(19) United States
(12) Patent Application Publication
(10) Pub. No.: US 2024/0134450 A1
(43) Pub. Date: Apr. 25, 2024

(54) CAMERA MODULE ALIGNMENT USING A FRAME

(71) Applicant: Meta Platforms Technologies, LLC, Menlo Park, CA (US)

(72) Inventors: Firmansyah Sulem, San Jose, CA (US); Kyung Won Park, Bellevue, WA (US)

(21) Appl. No.: 18/491,606

(22) Filed: Oct. 19, 2023

Related U.S. Application Data
(60) Provisional application No. 63/418,217, filed on Oct. 21, 2022.

(51) Int. Cl. G06F 3/01; G06F 3/0346; H04N 23/51; H04N 23/57

(52) U.S. Cl. CPC G06F 3/013; G06F 3/0346; H04N 23/51; H04N 23/57

(57) ABSTRACT

A wearable device with a display screen has both an image presentation area and a camera portion. The wearable device includes a camera module configured to capture images through the camera portion and a camera frame that is molded onto the display screen, creating a pocket in which the camera module is securely held. This camera frame is made of a material that not only keeps the camera module in place but also forms an environmental seal, effectively protecting the space between the camera module and the display screen.

### CROSS REFERENCE TO RELATED APPLICATIONS

This application claims the benefit of U.S. provisional patent application Ser. No. 63/418,217 entitled “Camera Module Alignment Using A Frame” filed on Oct. 21, 2022, which is incorporated by reference.

### FIELD OF THE INVENTION

The present disclosure generally relates to incorporating camera modules into small form factor devices, and specifically relates to camera module alignment using a frame.

### BACKGROUND

In traditional manufacturing processes, many electronic devices include an onboard camera that is integrated into a display unit. One common example of this setup is a front-facing camera on a smartphone or tablet. The conventional methods for incorporating these cameras into the overall system generally entail a multi-step procedure that can be both time-consuming and labor-intensive.

This multi-step assembly process can introduce inefficiencies into the manufacturing pipeline, extending the time required to assemble each unit and potentially increasing the margin for error, which in turn could result in higher production costs or quality control issues.

### SUMMARY

Embodiments described herein relate to a wearable device with a display screen that has both an image presentation area and a camera portion. It includes a camera module configured to capture images through the camera portion. What sets this device apart is the frame that is molded onto the display screen, creating a pocket in which the camera module is securely held. This frame is made of a material that not only keeps the camera module in place but also forms an environmental seal, effectively protecting the space between the camera module and the display screen. This innovative design enhances the functionality and durability of the wearable device.

### BRIEF DESCRIPTION OF THE DRAWINGS

FIG. 1A is a top view of an example wristband system, in accordance with one or more embodiments.

FIG. 1B is a side view of the example wristband system of FIG. 1A.

FIG. 2A is a perspective view of another example wristband system, in accordance with one or more embodiments.

FIG. 2B is a perspective view of the example wristband system with the watch body 204 released from the watch band, in accordance with one or more embodiments.

FIG. 3 illustrates an example frame molded to a display screen.

FIG. 4 illustrates the camera module incorporated into the frame of a watch.

FIG. 5 is a cross section of a portion of the watch in FIG. 4 that includes the frame and the camera module.

FIG. 6 is a high-level block diagram illustrating an example architecture of a computer, which may correspond to a wristband system described herein.

### DETAILED DESCRIPTION

Described herein is camera module alignment using a frame. A camera module is incorporated into the device using a frame. The frame may be part of a device frame (e.g., a relatively large structure that may provide structural support to the device) of the device or may be independent from the device frame. The device includes a display, and the device may be a wearable device (e.g., a watch). Note that while the figures below are in the context of a watch, in other embodiments, it may be some other device (e.g., smartphone). The frame is affixed to the display screen. The frame forms a pocket in which the camera module is held, and allows for quick assembly in which the camera module may be integrated into the device in a manner that automatically aligns the camera module to the display screen.

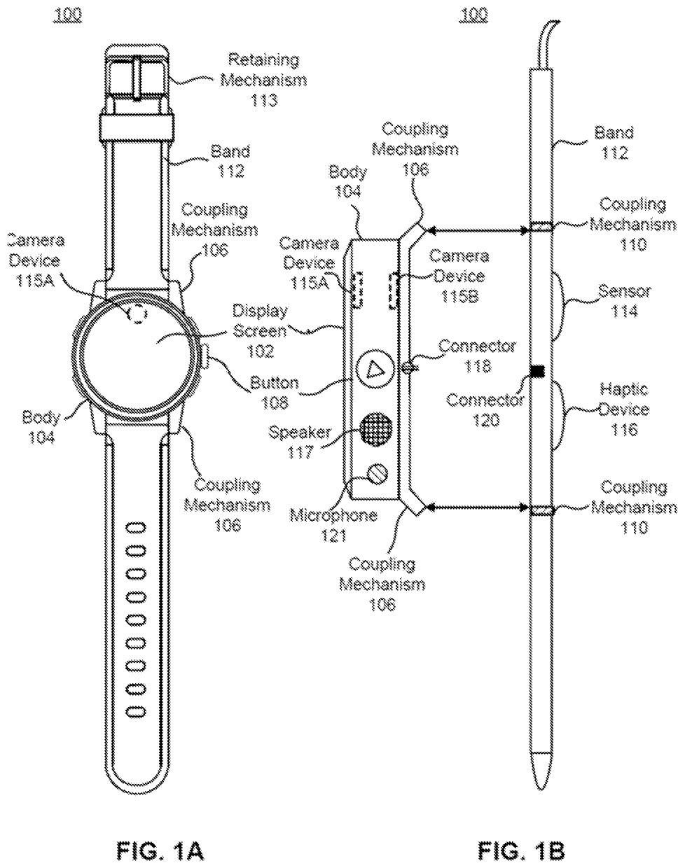

FIG. 1A is a top view of an example wristband system 100, in accordance with one or more embodiments. FIG. 1B is a side view of the example wristband system 100 of FIG. 1A. The wristband system 100 is an electronic wearable device and may be worn on a wrist or an arm of a user. In some embodiments, the wristband system 100 is a smartwatch. Media content may be presented to the user wearing the wristband system 100 using a display screen 102 and/or one or more speakers 117. However, the wristband system 100 may also be used such that media content is presented to a user in a different manner (e.g., via touch utilizing a haptic device 116). The haptic device 116 is configured to provide tactile feedback to the user, allowing them to feel and interact with the device or a virtual object in a more realistic way. Examples of media content presented by the wristband system 100 include one or more images, video, audio, or some combination thereof. The wristband system 100 may operate in an artificial reality environment, e.g., a virtual reality (VR) environment, an artificial reality (AR) environment, a mixed reality (MR) environment, or some combination thereof.

In some examples, the wristband system 100 may include multiple electronic devices (not shown) including, without limitation, a smartphone, a server, a head-mounted display (HMD), a laptop computer, a desktop computer, a gaming system, Internet of things devices, etc. Such electronic devices may communicate with the wristband system 100 (e.g., via a personal area network). The wristband system 100 may have sufficient processing capabilities (e.g., central processing unit (CPU), memory, bandwidth, battery power, etc.) to offload computing tasks from each of the multiple electronic devices to the wristband system 100. Additionally, or alternatively, each of the multiple electronic devices may have sufficient processing capabilities (e.g., CPU, memory, bandwidth, battery power, etc.) to offload computing tasks from the wristband system 100 to the electronic device(s).

The wristband system 100 includes a watch body 104 coupled to a watch band 112 via one or more coupling mechanisms 106, 110. The watch body 104 may include, among other components, one or more coupling mechanisms 106, one or more camera devices 115 (e.g., camera device 115A and 115B), the display screen 102, a button 108, a connector 118, a speaker 117, and a microphone 121. The watch band 112 may include, among other components, one or more coupling mechanisms 110, a retaining mechanism 113, one or more sensors 114, the haptic device 116, and a connector 120. While FIGS. 1A and 1B illustrate the components of the wristband system 100 in example locations on the wristband system 100, the components may be located elsewhere on the wristband system 100, on a peripheral electronic device paired with the wristband system 100, or some combination thereof. Similarly, there may be more or fewer components on the wristband system 100 than what is shown in FIGS. 1A and 1B. For example, in some embodiments, the watch body 104 may include a port for connecting the wristband system 100 to a peripheral electronic device and/or to a power source. The port may enable charging of a battery of the wristband system 100 and/or communication between the wristband system 100 and a peripheral device. In another example, the watch body 104 may include an inertial measurement unit (IMU) that measures a change in position, an orientation, and/or an acceleration of the wristband system 100. The IMU may include one or more sensors, such as one or more accelerometers, one or more gyroscopes, one or more magnetometers, another suitable type of sensor that detects motion, a type of sensor used for error correction of the IMU, or some combination thereof.

The watch body 104 and the watch band 112 may have any size and/or shape that is configured to allow a user to wear the wristband system 100 on a body part (e.g., a wrist). The wristband system 100 may include the retaining mechanism 113 (e.g., a buckle) for securing the watch band 112 to the wrist of the user. The coupling mechanism 106 of the watch body 104 and the coupling mechanism 110 of the watch band 112 may attach the watch body 104 to the watch band 112. For example, the coupling mechanism 106 may couple with the coupling mechanism 110 by sticking to, attaching to, fastening to, affixing to, some other suitable means for coupling to, or some combination thereof.

The wristband system 100 may perform various functions associated with the user. The functions may be executed independently in the watch body 104, independently in the watch band 112, and/or in communication between the watch body 104 and the watch band 112. In some embodiments, a user may select a function by interacting with the button 108 (e.g., by pushing, turning, etc.). In some embodiments, a user may select a function by interacting with the display screen 102. For example, the display screen 102 is a touchscreen and the user may select a particular function by touching the display screen 102. The functions executed by the wristband system 100 may include, without limitation, displaying visual content to the user (e.g., displaying visual content on the display screen 102), presenting audio content to the user (e.g., presenting audio content via the speaker 117), sensing user input (e.g., sensing a touch of button 108, sensing biometric data and/or neuromuscular signals with the one or more sensors 114, capturing audio content (e.g., capturing audio with microphone 121), capturing data describing a local area (e.g., with a front-facing camera device 115A and/or a rear-facing camera device 115B), communicating wirelessly (e.g., via cellular, near field, Wi-Fi, personal area network, etc.), communicating via wire (e.g., via the port), determining location (e.g., sensing position data with a sensor 114), determining a change in position (e.g., sensing change(s) in position with an IMU), determining an orientation and/or acceleration (e.g., sensing orientation and/or acceleration data with an IMU), providing haptic feedback (e.g., with the haptic device 116), etc.

The display screen 102 may display visual content to the user. The displayed visual content may be oriented to the eye gaze of the user such that the content is easily viewed by the user. Traditional displays on wristband systems may orient the visual content in a static manner such that when a user moves or rotates the wristband system, the content may remain in the same position relative to the wristband system causing difficulty for the user to view the content. The displayed visual content may be oriented (e.g., rotated, flipped, stretched, etc.) such that the displayed content remains in substantially the same orientation relative to the eye gaze of the user (e.g., the direction in which the user is looking). The displayed visual content may also be modified based on the eye gaze of the user. For example, in order to reduce the power consumption of the wristband system 100, the display screen 102 may dim the brightness of the displayed visual content, pause the displaying of visual content, or power down the display screen 102 when it is determined that the user is not looking at the display screen 102. In some examples, one or more sensors 114 of the wristband system 100 may determine an orientation of the display screen 102 relative to an eye gaze direction of the user. The display screen 102 including a portion through which images are presented and a camera portion. The camera portion is a portion of the display screen 102 through which the front-facing camera device 115A images.

The position, orientation, and/or motion of eyes of the user may be measured in a variety of ways, including through the use of optical-based eye-tracking techniques, infrared-based eye-tracking techniques, etc. For example, the front-facing camera device 115A and/or rear-facing camera device 115B may capture data (e.g., visible light, infrared light, etc.) of the local area surrounding the wristband system 100 including the eyes of the user. The captured data may be processed by a controller (not shown) internal to the wristband system 100, a controller external to and in communication with the wristband system 100 (e.g., a controller of an HMD), or a combination thereof to determine the eye gaze direction of the user. The display screen 102 may receive the determined eye gaze direction and orient the displayed content based on the eye gaze direction of the user.

In some embodiments, the watch body 104 may be communicatively coupled to an HMD. The front-facing camera device 115A and/or the rear-facing camera device 115B may capture data describing the local area, such as one or more wide-angle images of the local area surrounding the front-facing camera device 115A and/or the rear-facing camera device 115B. The wide-angle images may include hemispherical images (e.g., at least hemispherical, substantially spherical, etc.), 180-degree images, 360-degree area images, panoramic images, ultra-wide area images, or a combination thereof. In some examples, the front-facing camera device 115A and/or the rear-facing camera device 115B may be configured to capture images having a range between 45 degrees and 360 degrees. The captured data may be communicated to the HMD and displayed to the user on a display screen of the HMD worn by the user. In some examples, the captured data may be displayed to the user in conjunction with an artificial reality application. In some embodiments, images captured by the front-facing camera device 115A and/or the rear-facing camera device 115B may be processed before being displayed on the HMD. For example, certain features and/or objects (e.g., people, faces, devices, backgrounds, etc.) of the captured data may be subtracted, added, and/or enhanced before displaying on the HMD.

Components of the front-facing camera device 115A and the rear-facing camera device 115B may be capable of taking pictures capturing data describing the local area. A lens of the front-facing camera device 115A and/or a lens of the rear-facing camera device 115B can be automatically positioned at their target positions. A target position in a forward (or horizontal) posture of the front-facing camera device 115A may correspond to a position at which the lens of the front-facing camera device 115A is focused at a preferred focal distance (e.g., distance in the order of several decimeters). A target position in a forward (or horizontal) posture of the rear-facing camera device 115B may correspond to a position at which the lens of the rear-facing camera device 115B is focused at a hyperfocal distance in the local area (e.g., a distance of approximately 1.7 meter). An upward (vertical) posture of the front-facing camera device 115A (or the rear-facing camera device 115B) corresponds to a posture where an optical axis is substantially parallel to gravity. And a forward (horizontal) posture of the front-facing camera device 115A (or the rear-facing camera device 115B) corresponds to a posture when the optical axis is substantially orthogonal to gravity.

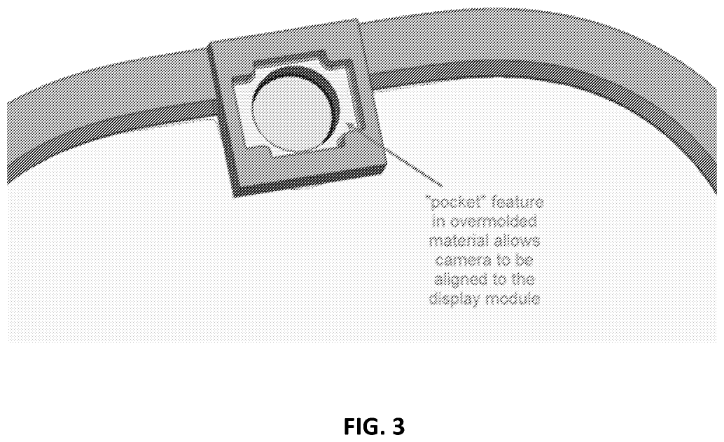

The front-facing camera device 115A may be referred to as a camera module. Note that the front-facing camera device 115A is positioned to image objects through the camera portion of the display screen 102. Integration of the front-facing camera device 115A via a frame is described below with regard to, e.g., FIGS. 3-5.

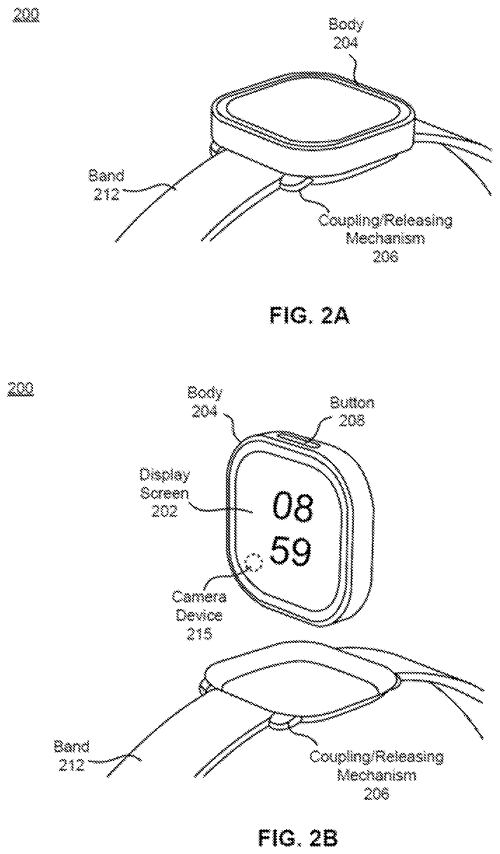

FIG. 2A is a perspective view of another example wristband system 200, in accordance with one or more embodiments. The wristband system 200 includes many of the same components described above with reference to FIGS. 1A and 1B, but a design or layout of the components may be modified to integrate with a different form factor. For example, the wristband system 200 includes a watch body 204 and a watch band 212 of different shapes and with different layouts of components compared to the watch body 104 and the watch band 112 of the wristband system 100. FIG. 2A further illustrates a coupling/releasing mechanism 206 for coupling/releasing the watch body 204 to/from the watch band 212.

FIG. 2B is a perspective view of the example wristband system 200 with the watch body 204 released from the watch band 212, in accordance with one or more embodiments. FIG. 2B further illustrates a camera device 215, a display screen 202, and a button 208. The camera device 215 (also referred to as a camera module) as shown is an embodiment of the front-facing camera device 115A. Integration of the camera device 215 via a frame is described below with regard to, e.g., FIGS. 3-5.

In some embodiments, another camera device may be located on an underside of the watch body 204 and is not shown in FIG. 2B. In some embodiments (not shown in FIGS. 2A-2B), one or more sensors, a speaker, a microphone, a haptic device, a retaining mechanism, etc. may be included on the watch body 204 or the watch band 212. As the wristband system 100 and the wristband system 200 are of a small form factor to be easily and comfortably worn on a wrist of a user, the corresponding camera devices 115, 215 and various other components of the wristband system 100 and the wristband system 200 described above are designed to be of an even smaller form factor and are positioned close to each other.

The camera module may be integrated into various locations on a display screen (e.g., the display screen 102) using a frame. For example, note that in FIG. 1A the front facing camera device 115A is located in a different position than the camera device 215 in FIG. 2B.

FIG. 3 illustrates an example frame molded to a display screen. As shown in FIG. 3, the frame is the square component that includes a recessed area to which a camera module may be inserted. The frame forms a pocket in which the camera module is held and functions to not only hold the camera module, but to align the camera module to the display screen. The frame is composed of a material that conforms to a portion of an exterior of the camera module to hold the camera module in place in x, y, and z. Additionally, the frame is composed of a material that conforms tightly to a holding surface of the camera module. The material may be, e.g., rubber, silicon, etc. In this manner, in addition to holding the camera module in place, the frame is able to provide an environmental seal for a volume between the camera module and the display screen. FIG. 3 also illustrates a portion of a device frame that is seen along a periphery of the display screen on both sides of the frame. As shown, the device frame and the frame are a single part that is composed of the same material. In other embodiments, the frame and the device frame are different parts that are both coupled to the display screen.

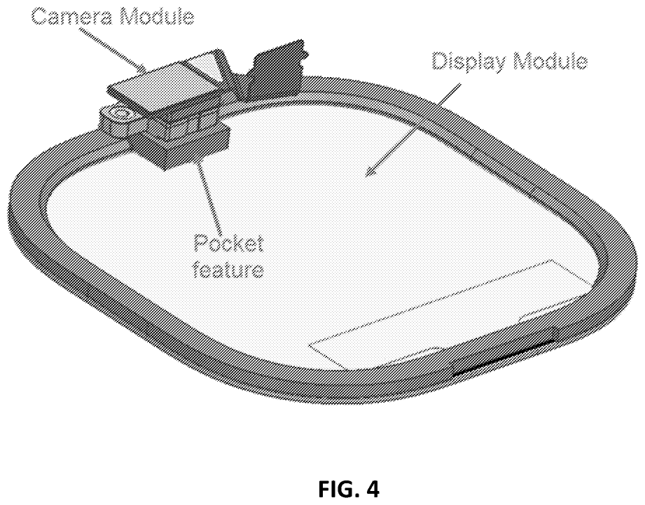

FIG. 4 illustrates the camera module incorporated into the frame of a watch. As shown in FIG. 4, the camera module may be mounted over a pocket feature, adjacent to a display module. Thus, the camera may be substantially co-located with the display without significantly reducing the limited display area. The pocket feature may detect if the watch is in a pocket and update the behavior of the watch accordingly (e.g., turning off the display of the watch while it is in a pocket).

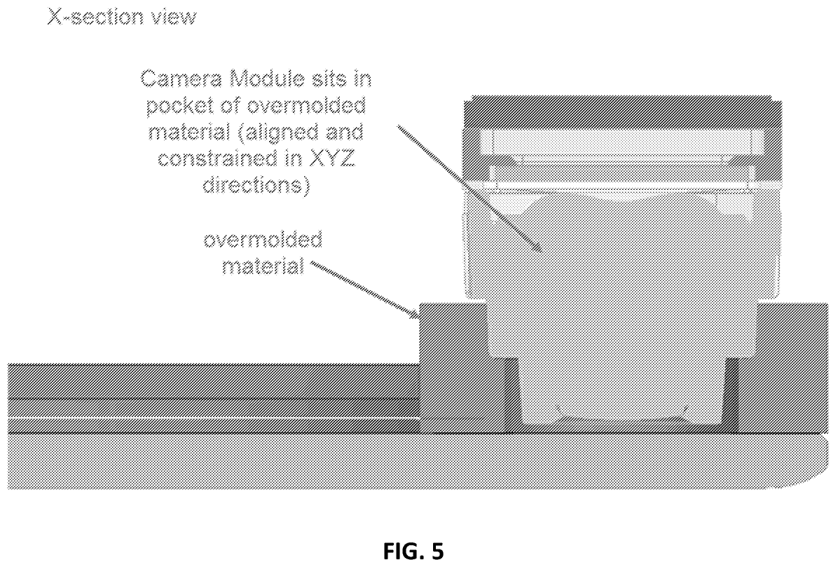

FIG. 5 is a cross section of a portion of the watch in FIG. 4 that includes the frame and the camera module. Note that camera module sits directly in the frame and there is no external gasket. In contrast, in some conventional systems a rigid plastic is used to generally position the camera module, and a separate external gasket is used to provide the environmental seal to keep dust from entering between the display screen and a lens of the camera module. Moreover, since the camera module is better aligned compared to conventional alignment methods, the resultant camera opening/aperture artwork on the glass can be minimized.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

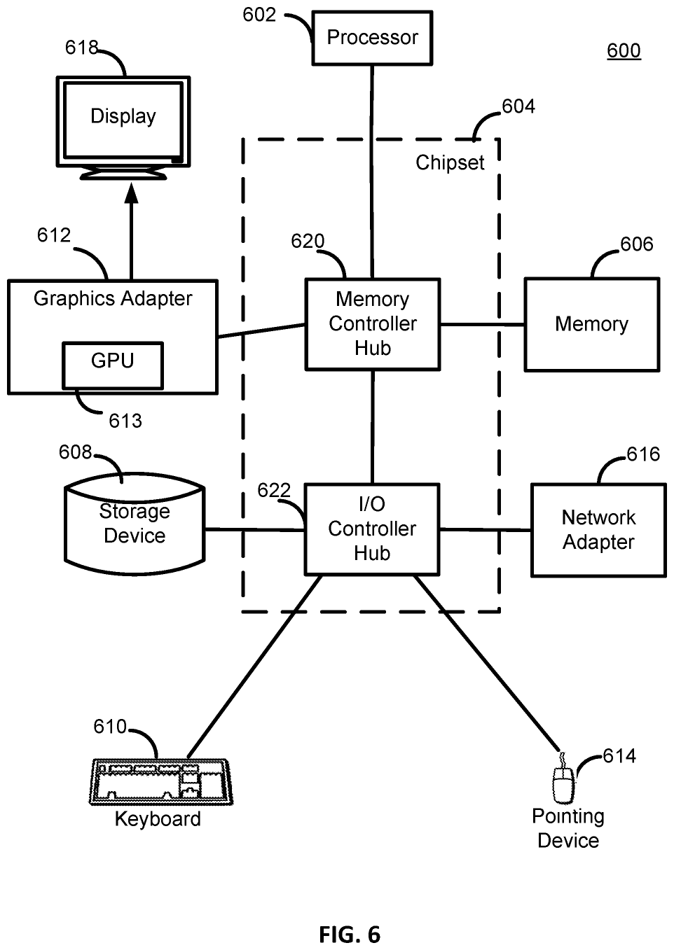

The wearable device described herein may include one or more processors and function as a computer system. The wearable device described herein may also be configured to interact and communicate with other computer systems, including (but not limited to) AR or VR devices, mobile devices, personal computers. FIG. 6 is a high-level block diagram illustrating an example architecture of a computer 600 which may correspond to the wearable device 100 of FIG. 1 or another device that the wearable device 100 is capable of communicating with.

The example computer 600 may be accessible by users via a computer network. For example, the example computer 600 may be a remote computing system hosted on a cloud platform and/or a virtual machine provided by a cloud service. The example computer 600 includes at least one processor 602 coupled to a chipset 604. The chipset 604 includes a memory controller hub 620 and an input/output (I/O) controller hub 622. A memory 606 and a graphics adapter 612, which contains a graphics processing unit (GPU) 613, are coupled to the memory controller hub 620, and a display 618 is coupled to the graphics adapter 612. A storage device 608, keyboard 610, pointing device 614, and network adapter 616 are coupled to the I/O controller hub 622. Other embodiments of the computer 600 have different architectures.

In the embodiment shown in FIG. 6, the storage device 608 is a non-transitory computer-readable storage medium such as a hard drive, compact disk read-only memory (CD-ROM), DVD, or a solid-state memory device. The memory 606 holds instructions and data used by the processor 602. The pointing device 614 is a mouse, track ball, touch-screen, or other type of pointing device, and is used in combination with the keyboard 610 (which may be an on-screen keyboard) to input data into the computer 600. The graphics adapter 612 displays images and other information on the display 618. The network adapter 616 couples the computer 600 to one or more computer networks.

The GPU 613 in the graphics adapter 612 may be used for other high-performance computation as well as processing graphical data for presentation on the display 618. In one embodiment, the GPU 613 is used to process data from the image segmentation system 125, where it is used to accelerate model training, image processing, and image segmentation.

The types of computers used by the entities of FIG. 6 can vary depending upon the embodiment and the processing power required by the entity. For example, the image segmentation system 125 might include a desktop computer to provide the functionality described. Furthermore, the computers can lack some of the components described above, such as keyboards 610, graphics adapters 612, and displays 618.

### ADDITIONAL CONFIGURATION INFORMATION

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A wearable device comprising:
a display screen, the display screen including a portion through which images are presented and a camera portion;
a camera module positioned to image objects through the camera portion; and
a camera frame that is molded to the display screen, wherein the frame forms a pocket in which the camera module is held, and the frame comprises a material that conforms to a portion of an exterior of the camera module to hold the camera module in place and provide an environmental seal for a volume between the camera module and the display screen.

2. The wearable device of claim 1, wherein the material includes at least one of rubber or silicon.

3. The wearable device of claim 2, wherein the material includes at least one of rubber or silicon.

4. The wearable device of claim 1, further comprising a device frame configured to house the display screen, wherein the camera frame is coupled to the device frame.

5. The wearable device of claim 4, wherein the device frame and the camera frame are composed of a same material.

6. The wearable device of claim 4, wherein the device frame and the camera frame are composed of a different material.

7. The wearable device of claim 1, wherein the camera module comprises a front camera facing the display screen of the wearable device.

8. The wearable device of claim 7, wherein the camera module further comprises a back camera facing a back surface of the wearable device opposite to the display screen of the wearable device.

9. The wearable device of claim 1, further comprising a haptic device configured to provide tactile feedback to a user.

10. The wearable device of claim 1, further comprising one or more speakers configured to play audio signals.

11. The wearable device of claim 1, further comprising one or more microphones configured to detect audio signals.

12. The wearable device of claim 1, further comprising one or more sensors configured to sense biometric data.

13. The wearable device of claim 1, further comprising one or more sensors configured to sense neuromuscular signals.

14. The wearable device of claim 1, further comprising an inertial measurement unit (IMU) configured to detect a change in position, orientation, or acceleration of the wearable device.

15. The wearable device of claim 1, wherein the display screen is configured to be oriented based on an orientation detected by the IMU, or a user's face or eye gaze detected by the camera.

16. The wearable device of claim 1, the wearable device configured to:
detect whether a user is looking at the display screen; and
responsive to detecting that the user is no longer looking at the display screen, reducing power consumption of the wearable device by at least one of (1) diming a brightness of displayed visual content, (2) pausing displaying of visual content, or (3) powering down the display screen.
